(19) United States
(12) Patent Application Publication
(10) Pub. No.: US 2009/0140513 A1
(43) Pub. Date: Jun. 4, 2009

(54) PRESCRIPTION CONTAINERS AND LABELING METHOD

(76) Inventors: Robert N. Priebe, Bloomington, MN (US); Terrance O. Noble, Burnsville, MN (US)

Correspondence Address: MERCHANT & GOULD PC, P.O. BOX 2903, MINNEAPOLIS, MN, 55402-0903, US

(21) Appl. No.: 12/325,548

(22) Filed: Dec. 1, 2008

Related U.S. Application Data
(60) Provisional application No. 61/005,304, filed on Dec. 3, 2007.

(51) Int. Cl. B42D 15/10; A61J 1/14

(52) U.S. Cl. 283/81; 206/459.5

(57) ABSTRACT

An improved container for storing prescription medication and an improved prescription container labeling system. A method of storing medication using the labeling system and containers.

This application claims priority to U.S. provisional patent application 61/005,304 filed Dec. 3, 2007. The complete disclosure of application 61/005,304 is incorporated herein by reference.

### TECHNICAL FIELD

The disclosure relates to containers for prescription medication and a method of labeling the containers.

### BACKGROUND

Labeled containers for prescription medication are known. Typically, the prescription medication containers are generally cylindrical in shape. The cylindrical shape is desirable at least because for a given amount of container material a cylindrical shaped container provides a relatively large container volume. Containers for prescription medication generally included labels thereon. The labels are typically adhered to the curved surface of the container and include words oriented horizontally around the container. The present disclosure provides an improved prescription medication container and label arrangement.

### SUMMARY

The present disclosure provides an improved container for storing prescription medication. The disclosure is also directed to an improved prescription container labeling system and a method of storing medication using the labeling system and containers.

### BRIEF DESCRIPTION OF THE DRAWINGS

FIG. 1 is a front view of a plurality of labeled medication containers according to the present disclosure arranged on an upper shelf and plurality of prior art labeled prescription medication containers arranged on a lower shelf;

FIG. 2 is a front end view of a labeled medication container according to the present disclosure;

FIG. 3A is a front side view of the labeled medication container according to FIG. 2;

FIG. 3B is a back side view of the labeled medication container according to FIG. 2;

FIG. 4A is a first example of a four panel label according to the present disclosure;

FIG. 4B is a second example of a four panel label according to the present disclosure;

FIG. 4C is a third example of a four panel label according to the present disclosure;

FIG. 5A is a perspective view of a medication container and double-sided cap according to an embodiment of the present disclosure;

FIG. 5B is a side view of the medication container and cap of FIG. 5A;

FIG. 5C is an end view of the medication container and cap of FIG. 5A;

FIG. 5D is a cross-section view of the medication container and cap of FIG. 5A along line 5D-5D of FIG. 5B;

FIG. 5E is a top view of the medication container and cap of FIG. 5A;

FIG. 5F is a bottom view of the medication container and cap of FIG. 5A;

FIG. 6A is a perspective view of a medication container and double-sided cap according to an embodiment of the present disclosure;

FIG. 6B is a side view of the medication container and cap of FIG. 6A; FIG. 6C is an end view of the medication container and cap of FIG. 6A;

FIG. 6D is a top view of the medication container and cap of FIG. 6A;

FIG. 6E is a bottom view of the medication container and cap of FIG. 6A;

FIG. 7A is a perspective view of a medication container (no cap) according to an embodiment of the present disclosure;

FIG. 7B is a side view of the medication container of FIG. 7A;

FIG. 7C is an end view of the medication container of FIG. 7A;

FIG. 7D is a cross-section view of the medication container of FIG. 7A along line 7D-7D of FIG. 7B;

FIG. 7E is a top view of the medication container of FIG. 7A;

FIG. 7F is a bottom view of the medication container of FIG. 7A;

FIG. 8A is a perspective view of a medication container and cap according to an embodiment of the present disclosure;

FIG. 8B is a side view of the medication container and cap of FIG. 8A; FIG. 8C is an end view of the medication container and cap of FIG. 8A;

FIG. 8D is a cross-section view of the medication container and cap of FIG. 8A along line 8D-8D of FIG. 8B;

FIG. 8E is a top view of the medication container and cap of FIG. 8A;

FIG. 8F is a bottom view of the medication container and cap of FIG. 8A;

FIG. 9A is a perspective view of a medication container and double-sided cap according to an embodiment of the present disclosure;

FIG. 9B is a side view of the medication container and cap of FIG. 9A;

FIG. 9C is an end view of the medication container and cap of FIG. 9A;

FIG. 9D is a top view of the medication container and cap of FIG. 9A;

FIG. 9E is a bottom view of the medication container and cap of FIG. 9A;

FIG. 10A is a perspective view of a medication container (no cap) according to an embodiment of the present disclosure;

FIG. 10B is a side view of the medication container of FIG. 10A;

FIG. 10C is an end view of the medication container of FIG. 10A;

FIG. 10D is a cross-section view of the medication container of FIG. 10A along lines 10D-10D of FIG. 10B;

FIG. 10E is a top view of the medication container of FIG. 10A;

FIG. 10F is a bottom view of the medication container of FIG. 10A;

FIG. 11A is a perspective view of a medication container and cap according to an embodiment of the present disclosure;

FIG. 11B is a side view of the medication container and cap of FIG. 11A;

FIG. 11C is an end view of the medication container and cap of FIG. 11A;

FIG. 11D is a cross-section view of the medication container and cap of FIG. 11a along line 11D-11D of FIG. 11B;

FIG. 11E is a top view of the medication container and cap of FIG. 11A;

FIG. 11F is a bottom view of the medication container and cap of FIG. 11A;

FIG. 12A is a perspective view of a medication container and double-sided cap according to an embodiment of the present disclosure;

FIG. 12B is a side view of the medication container and cap of FIG. 12A;

FIG. 12C is an end view of the medication container and cap of FIG. 12A;

FIG. 12D is a top view of the medication container and cap of FIG. 12A;

FIG. 12E is a bottom view of the medication container and cap of FIG. 12A;

FIG. 13A is a perspective view of a medication container (no cap) according to an embodiment of the present disclosure;

FIG. 13B is a side view of the medication container of FIG. 13A; FIG. 13C is an end view of the medication container of FIG. 13A;

FIG. 13D is a cross section view of the medication container of FIG. 13A along lines 13D-13D of FIG. 13B;

FIG. 13E is a top view of the medication container of FIG. 13A;

FIG. 13F is a bottom view of the medication container of FIG. 13A;

FIG. 14A is a perspective view of a two-sided cap for a medication container;

FIG. 14B is a top view of the cap of FIG. 14A;

FIG. 14C is a side view of the cap of FIG. 14A;

FIG. 14D is a cross-sectional view of the cap of FIG. 14A along line 14D-14D of FIG. 14C;

FIG. 14E is a bottom view of the cap of FIG. 14A;

FIG. 15A is a perspective view of a non-child proof cap for a medication container;

FIG. 15B is a top view of the cap of FIG. 15A;

FIG. 15C is a side view of the cap of FIG. 15A;

FIG. 15D is a cross-sectional view of the cap of FIG. 15A along line 15D-15D of FIG. 15C;

FIG. 15E is a bottom view of the cap of FIG. 15A;

FIG. 16A is a perspective view of a child proof cap for a medication container;

FIG. 16B is a top view of the cap of FIG. 16A,

FIG. 16C is a side view of the cap of FIG. 16A;

FIG. 16D is a cross-sectional view of the cap of FIG. 16A along line 16D-16D of FIG. 16C;

FIG. 17 is a schematic illustration of the labeling network system;

FIG. 18A is a perspective view of another embodiment of a double-sided cap, similar to the embodiment of the cap illustrated in FIGS. 6A-6F, but in this case showing a 10-sided cap;

FIG. 18B is a top plan view of the cap of FIG. 18A;

FIG. 18C is a bottom plan view of the cap of FIG. 18A;

FIG. 18D is a side-elevational view of the cap of FIG. 18A; and

FIG. 18E is a cross-sectional view of the cap of FIG. 18A taken along the line 18E-18E of FIG. 18D.

### DETAILED DESCRIPTION

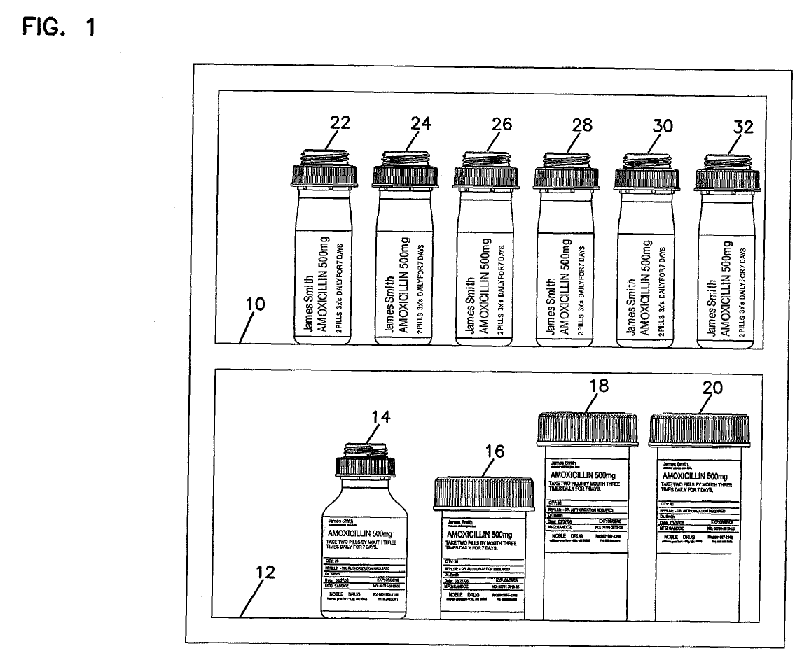

Referring to FIG. 1 an embodiment of the medication container system according to the present disclosure is shown on an upper shelf 10, and prior art medication containers are shown on a lower shelf 12. The prior art containers are generally cylindrical in shape and have a medication label affixed around the outer curved surface of the container. Given the cylindrical shape of the depicted prior art containers and the orientation of the text on the labels, the labels can be difficult to read without physically rotating the container. In addition, the cylindrical shape of the prior art containers can be difficult to horizontally stack and align so that the labels face outwardly. Prior art container 14 is shown aligned so that the label faces outwardly, whereas prior art containers 16, 18, 20 are misaligned. The diameter of the prior art containers limit the amount of information and/or the font size of the information that can be included on the label of the containers.

The medication container system of the depicted embodiment includes a plurality of containers 22, 24, 26, 28, 30, 32 that are shaped such that they can be easily horizontally stacked and aligned such that a particular portion of the label is facing outward. In the depicted embodiment, the wall of the containers configured to face outwardly (also referred to herein as the spine, end face, front face, front surface) is generally flat, as compared to the surface of an entirely cylindrical container of the prior art. In the depicted embodiment, the end face is taller than it is wide. The text on the end face is arranged vertically on the bottle so that the text can be of a sufficiently large font size yet still not extend out of view.

It should be appreciated that in alternative embodiments the text can be arranged differently. For example, the text can be arranged horizontally when the width of the end face is large enough to accommodate text that is of sufficiently large font size. In the depicted embodiment the end surface includes the user name (also referred to herein as the patient name), the name of the medication (also referred to herein as the name of the drug, vitamin, or supplement), and dosage information.

It should be appreciated that in alternative embodiments different classes or types or combinations of such information can be included on the surface of the spine. For example, in an alternative embodiment the spine can include the user's name and a supplement name without dosage information. In the depicted embodiment the spine is used to convey the most relevant information about the content within the container. For example, in some embodiments the expiration date and doctor's name are less relevant than the patient's name and medication name; therefore, in those embodiments the expiration date and doctor's name are not included on the spine of the containers. It should be appreciated that the relative relevance of particular types of information can vary depending on the particular application, for example, the medication context verses the supplement context.

Still referring to FIG. 1, the plurality of containers 22, 24, 26, 28, 30, 32 contain medication for a number of different individuals. In the depicted embodiment, containers 22, 30 contain Jerry's medications, containers 24, 28 contain Jenny's medications, and containers 26, 32 contain James's medication. In addition to, or in place of, including the name of the user on the spine, the spine, or a portion of the spine, can be otherwise coded to correspond to particular users or medications. For example, the labels on containers 22, 30 containing Jerry's medications can be of a first color, containers 24, 28 containing Jenny's medications can be of a second color, and containers 26, 32 containing James's medication can be of a third color.

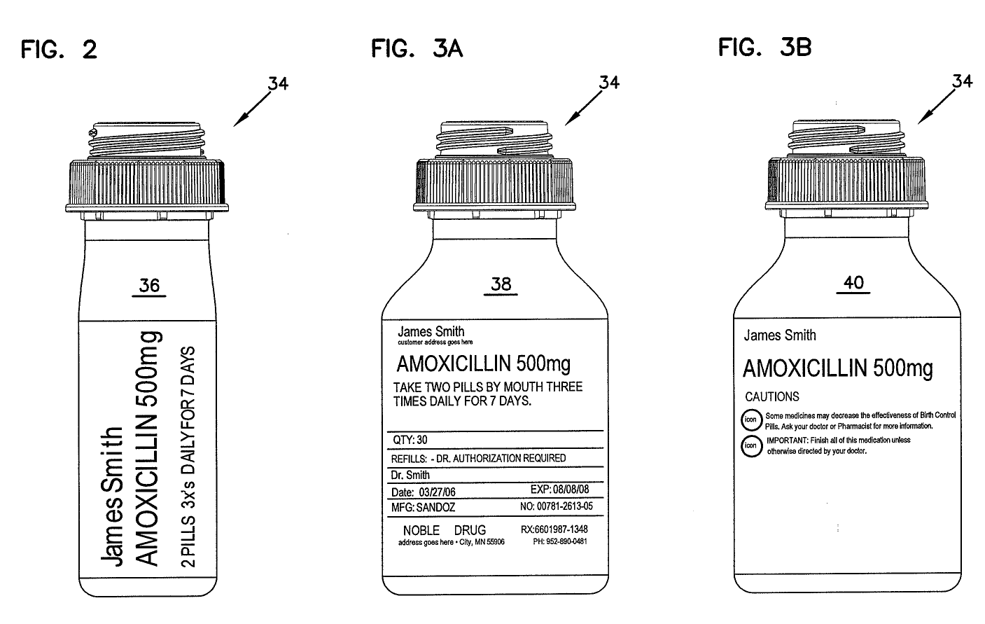

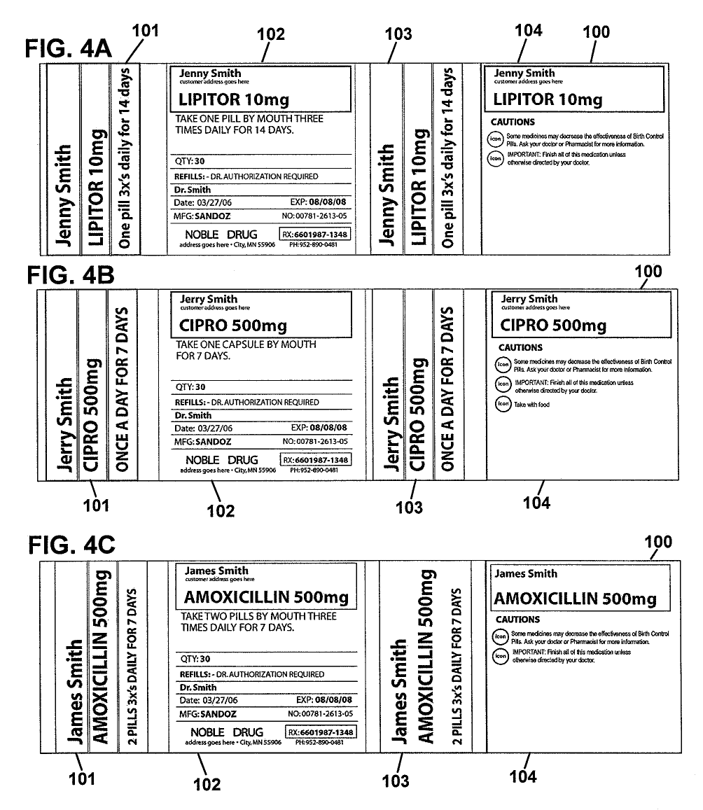

Referring to FIGS. 2, 3A, and 3B, an example medication container 34 is shown. FIG. 2 shows the end face 36 of the container 34, FIG. 3A shows a first side face 38, and FIG. 3B shows a second side face 40. The side surfaces 38 and 40 are opposed surfaces of the container and have the same general shape. In the depicted embodiment the area of the side surfaces 38 and 40 is larger than the area of the end face 36. The area of the side surfaces 38, 40 of the depicted embodiment is greater than twice the area of the end surface 36. In the depicted embodiment labels are affixed to both of the side surfaces. The labels are affixed to the surface of the container to communicate information to the user in an organized and user-friendly manner.

In the depicted embodiment, only one of the end faces is shown, as they are identical. The label on end face 36 includes the first and last name of the user (James Smith), an identification of the medication (Amoxicillin 500 mg), and dosage information (2 polls 3×'s daily for 7 days). In the depicted embodiment, the label on the first and second side faces 38, 40 includes some of the same information on the end face 36, as well as some additional information. Additionally, the first side 38 face includes quantity information (QTY: 30), refill information (Refills: DR. AUTHORIZATION REQUIRED), doctor name (Dr. Smith), date the prescription was filled (Date: Mar. 27, 2006), date the medication expires (EXP: Aug. 8, 2008), manufacture information (MFG: SANDOZ, NO: 00781-2613-05), and drug store information (NOBEL DRUG, RX 6601987-1348).

In the depicted embodiment the text on the first side 38 is horizontally oriented and in smaller font that the text on the end face 36. In the depicted embodiment, the second side face 40 includes side effect and/or warning information oriented horizontally, along with visual icons. In the depicted embodiment the text size of the warnings is sufficiently small to allow the second side to contain all the necessary warning information thereon.

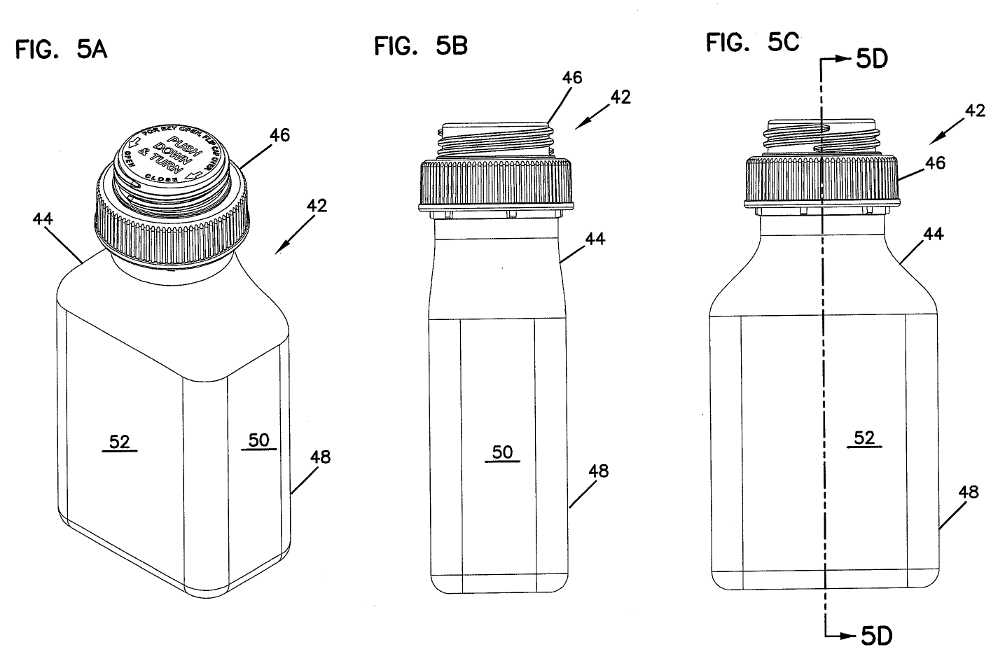

Referring to FIGS. 4A, 4B, and 4C, three labels 100 are shown. In the depicted embodiment the labels 100 are configured to be affixed to a medication container.

Each of the labels 100 includes four panels 101, 102, 103, 104 that can be aligned on four outer surfaces of a medication container. The panels 101-104 can be connected together as a single strip and connected to the container as one unit, or it can be separated into more than one piece and connected separately. In the depicted embodiment the labels 100 include text of various font sizes, font types, and letter orientations. In addition, the labels 100 in each of the FIGS. include highlighting of different color. It should be appreciate that in alternative embodiments the label 100 may include more or fewer panels. For example, an alternative embodiment can include an additional panel configured to be adhered to the bottom surface of the container or the cap of the container. In such an embodiment the containers can be stacked one on top of each other on their side surface and still be identified easily.

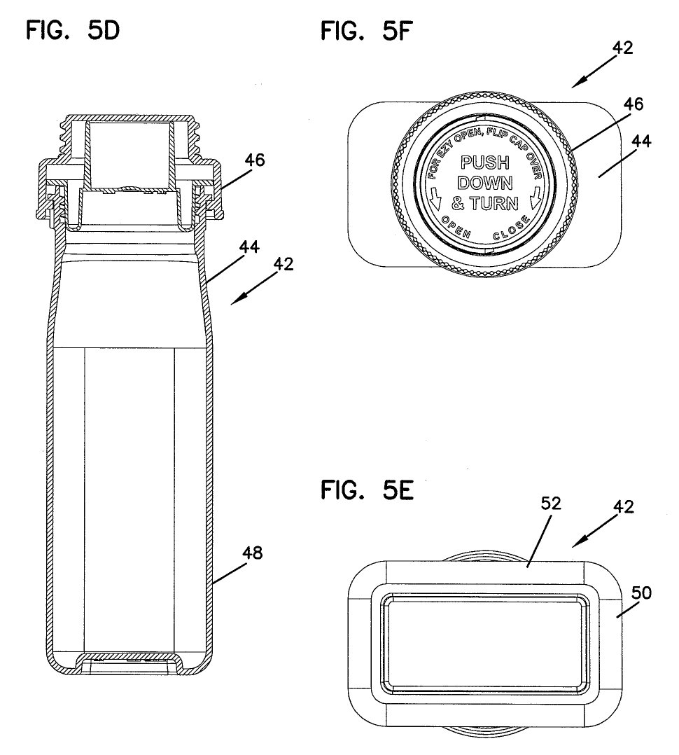

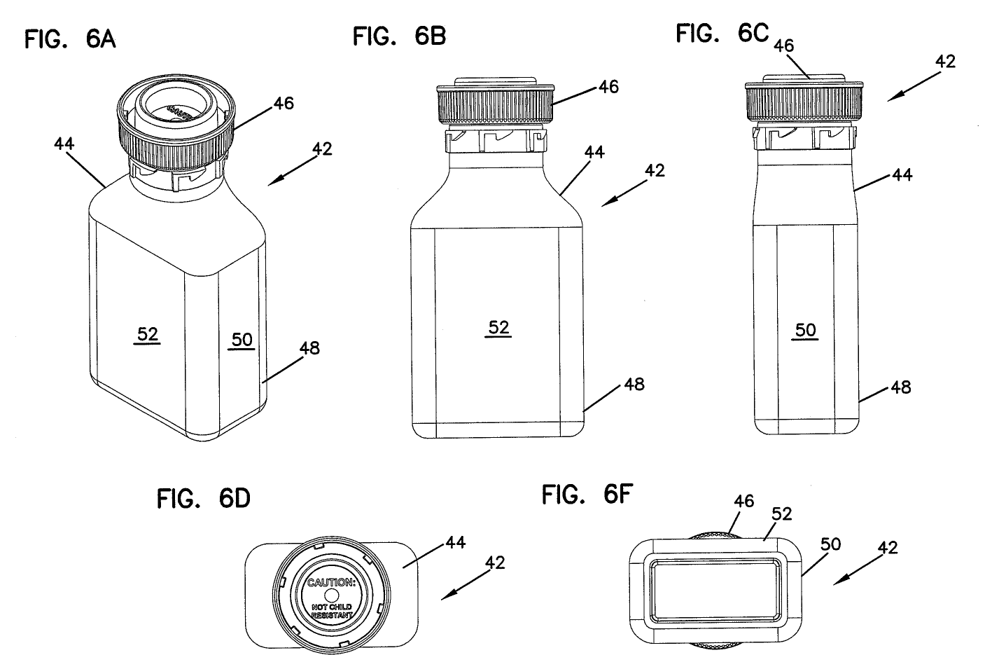

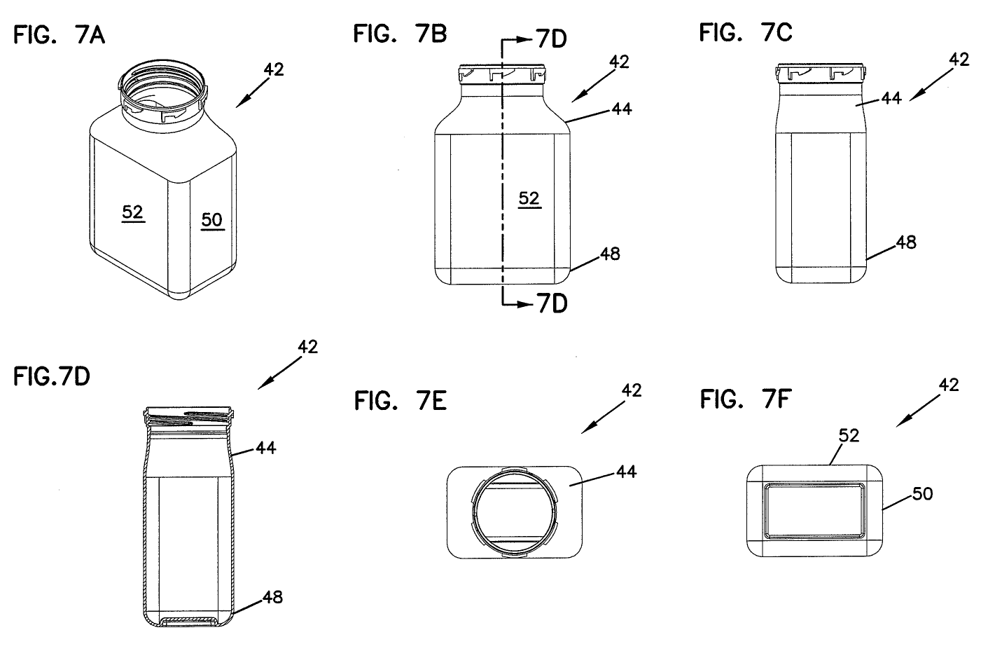

Referring to FIGS. 5a-5f, 6a-e, and 7a-f, a medium height container embodiment of a medication container is shown. The container 42 includes an upper end 44 configured to connect to a two-sided cap 46, a lower end 48 configured to support the container on a horizontal surface, an end surface 50 extending from the lower end to the upper end, a side surface 52 extending from the lower end to the upper end. In the depicted embodiment the end surface 50 and the side surface 52 are substantially flat and oriented perpendicular to each other. The area of the side surface 52 is greater than the area of the end surface 50. In the depicted embodiment, the lower end 48 includes a rectangular shaped base 49 from which the end and side walls of the container extend. The two-sided cap 46 has a child proof side and a non-child proof side. The child proof side is shown engaged with the upper end 44 of the container 42. Referring to FIGS. 6A-6E, the non-child proof side of the cap 46 is shown engaged with the upper end 44 of the container 42. Referring to FIGS. 7A-7F, the container 42 is shown without the cap.

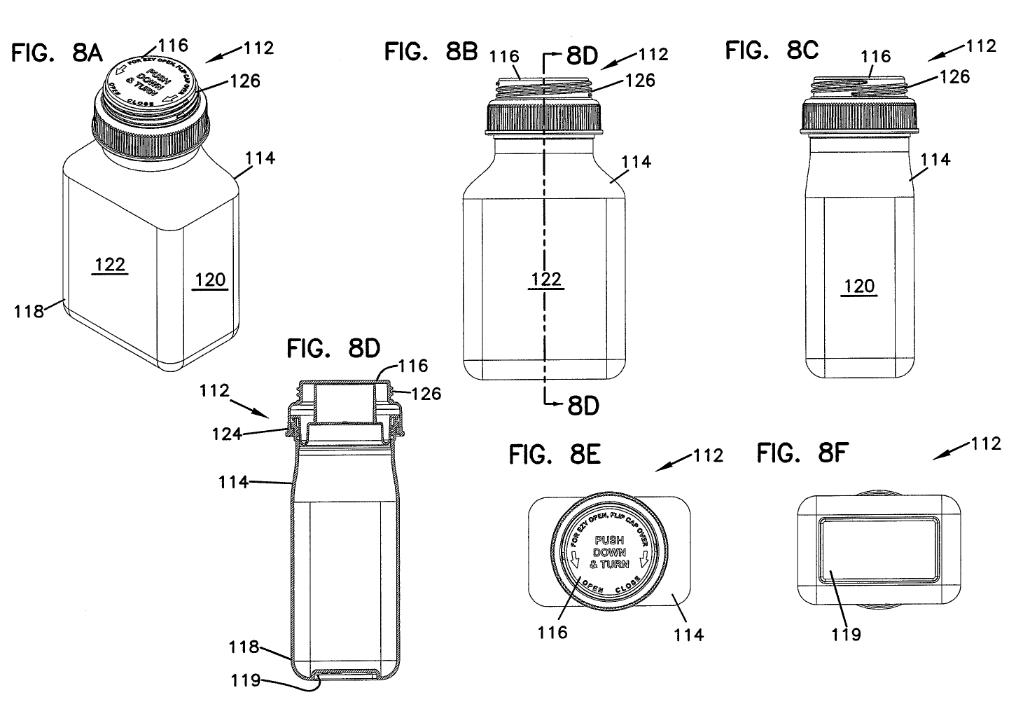

Referring to FIGS. 8A-8F, 9A-9E, and 10A-10F, a short container embodiment of a medication container 112 is shown. The short container 112 includes similar features as described above with reference to the medium height container. The short height container includes an upper end 114, a lower end 118, an end surface 120 extending from the lower end 118 to the upper end 114, and a side surface 122 extending from the lower end 118 to the upper end 114. The end surface 120 and the side surface 122 are substantially flat and oriented perpendicular to each other. The area of the side surface 122 is greater than the area of the end surface 120. The lower end 118 includes a rectangular shaped base 119 from which the end and side walls of the container extend. The two-sided cap 116 has a child proof side 124 and a non-child proof side 126.

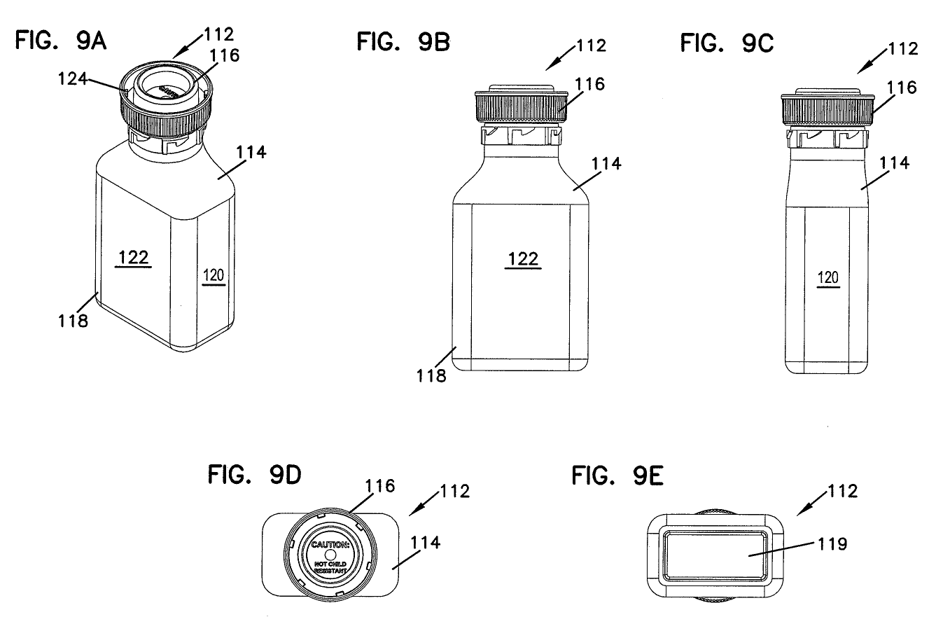

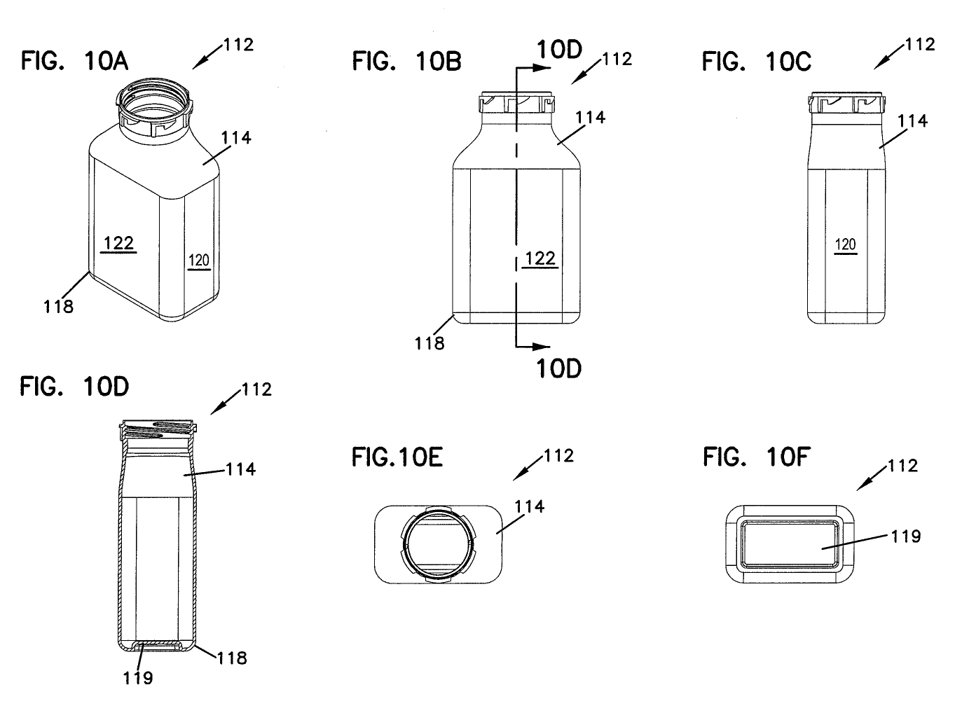

The child proof side 124 is shown engaged with the upper end 114 of the container 112. Referring to FIGS. 9A-9E, the non-child proof side 126 of the cap 116 is shown engaged with the upper end 114 of the container 112. Referring to FIGS. 10A-10F, the container 114 is shown without the cap 116.

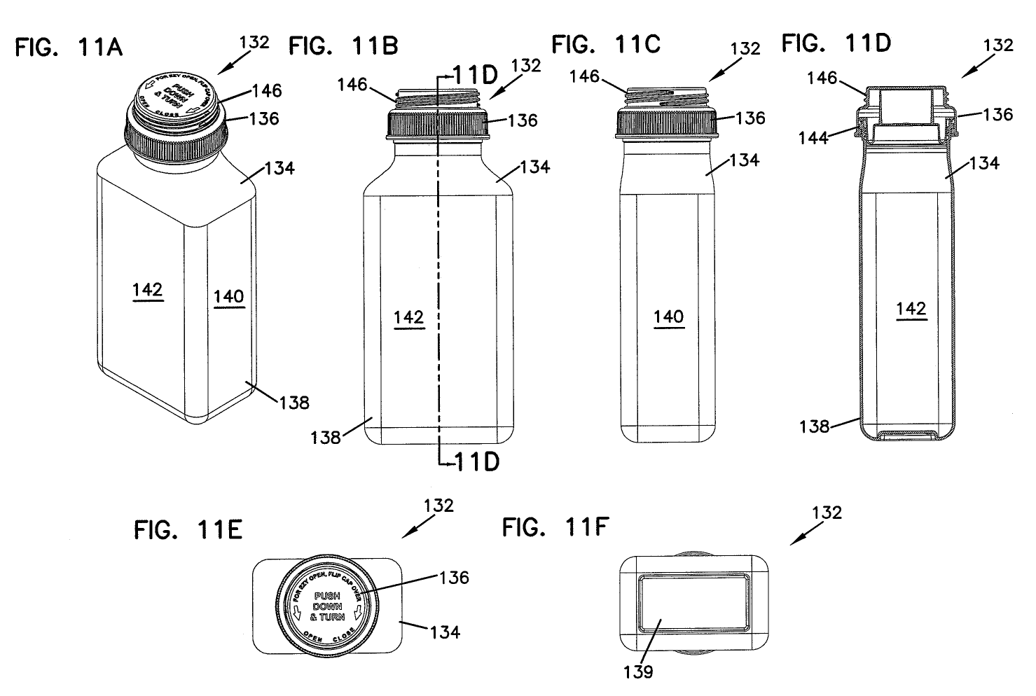

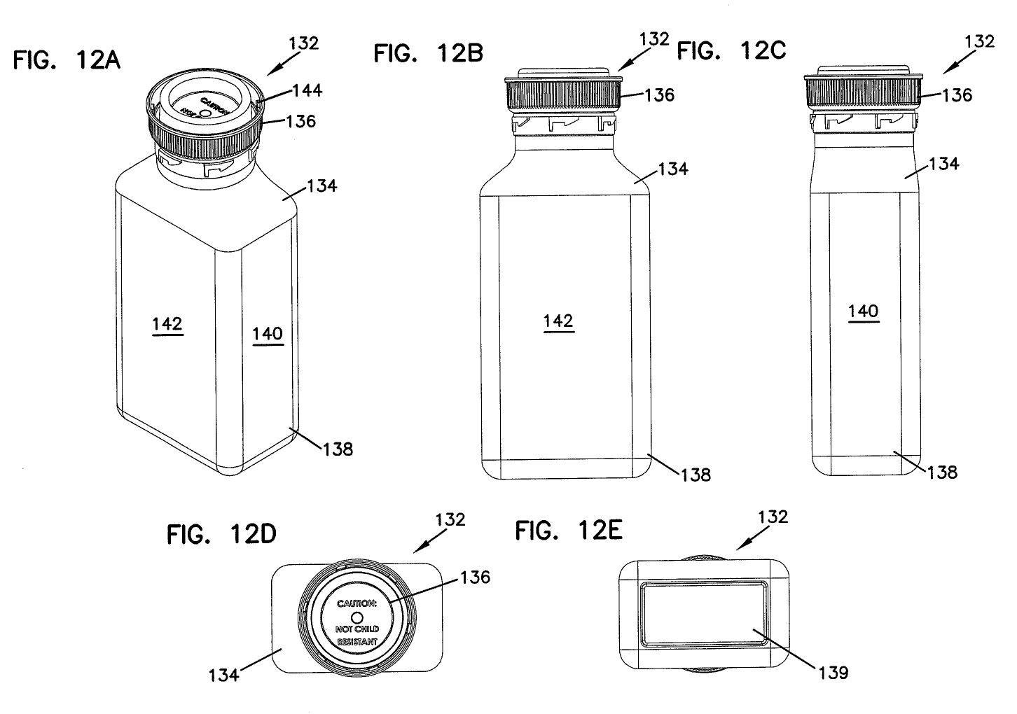

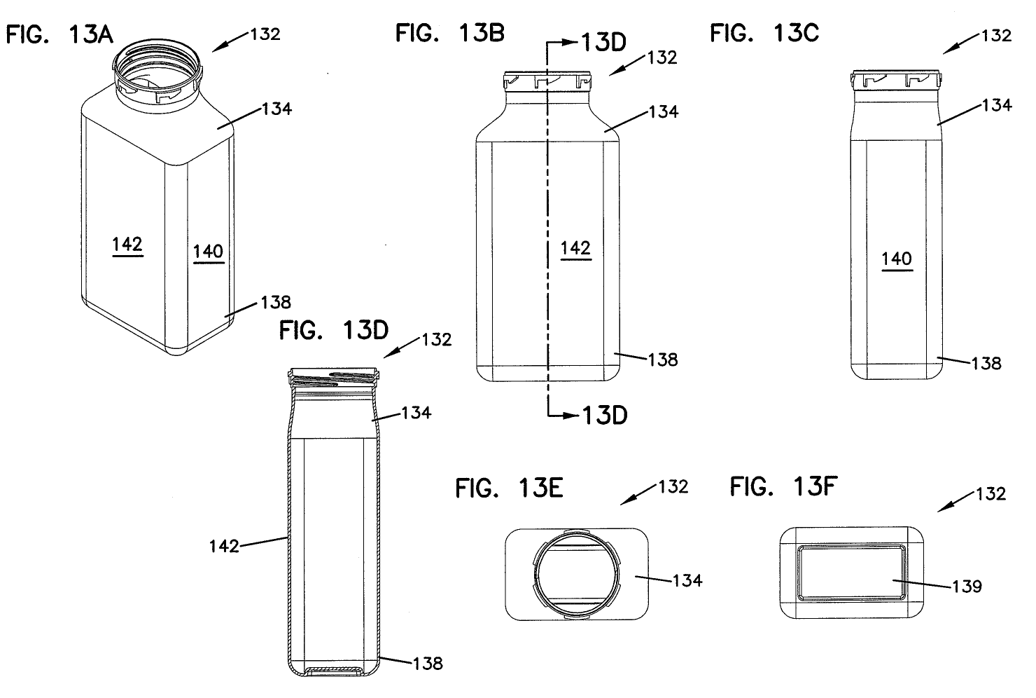

Referring to FIGS. 11A-11F, 12A-12E, and 13A-13F, a tall container embodiment of a medication container 132 is shown. The tall container 132 includes similar features as described above with reference to the medium height container 112. The tall height container 132 includes an upper end 134, a lower end 138, an end surface 140 extending from the lower end 138 to the upper end 134, and a side surface 142 extending from the lower end 138 to the upper end 134. The end surface 140 and the side surface 142 are substantially flat and oriented perpendicular to each other. The area of the side surface 142 is greater than the area of the end surface 140. The lower end 138 includes a rectangular shaped base 139 from which the end 140 and side walls 142 of the container 132 extend. The two-sided cap 136 has a child proof side 144 and a non-child proof side 146. The child proof side 144 is shown engaged with the upper end 134 of the container 132. Referring to FIGS. 12a-12e, the non-child proof side 146 of the cap 136 is shown engaged with the upper end 134 of the container 132. Referring to FIGS. 13A-13F, the container is shown without the cap 136.

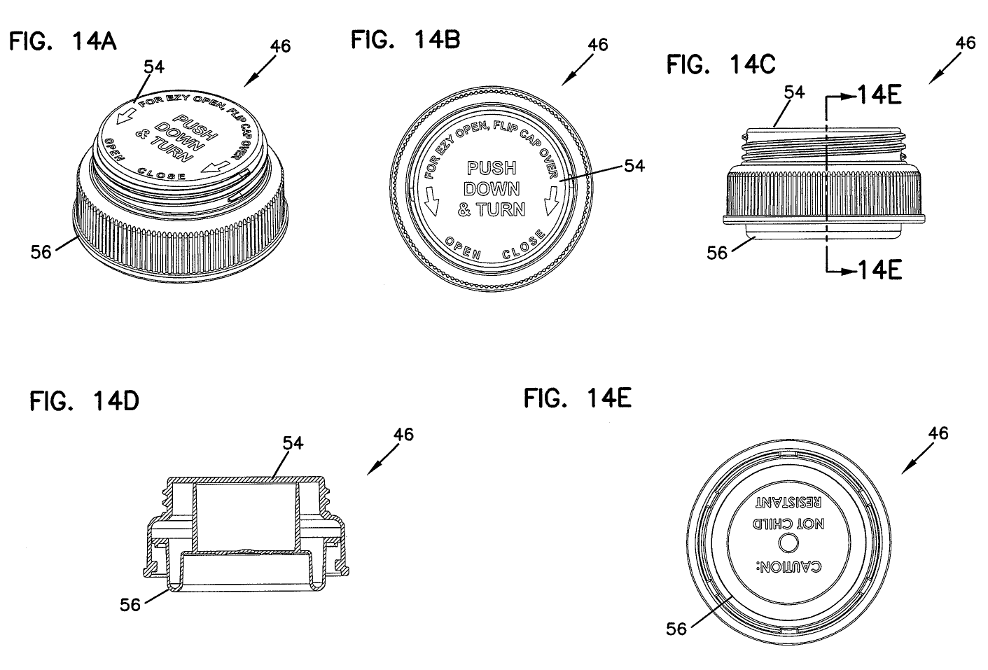

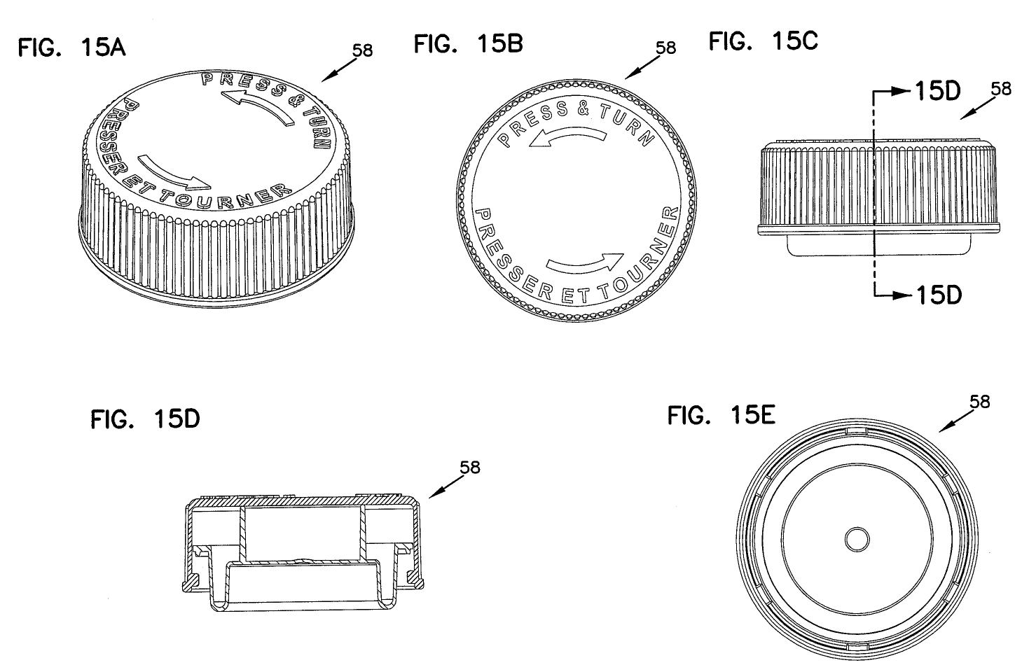

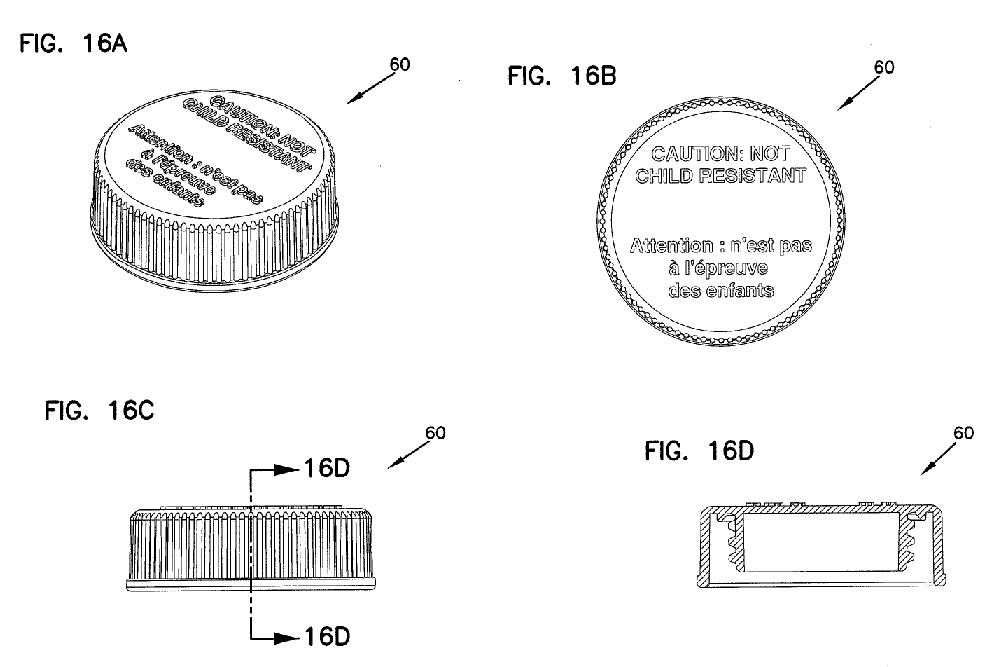

Referring to FIGS. 14A-14E, the two-sided cap 46 is shown in greater detail. The two-sided cap includes a first side 54 that provides a non-child proof connection to the container, whereas the second side 56 provides a child proof connection to the container. Referring to FIGS. 15A-15E, a child proof single-sided cap 58 is shown. Referring to FIGS. 16A-16D, a non-child proof single-sided cap 60 is shown.

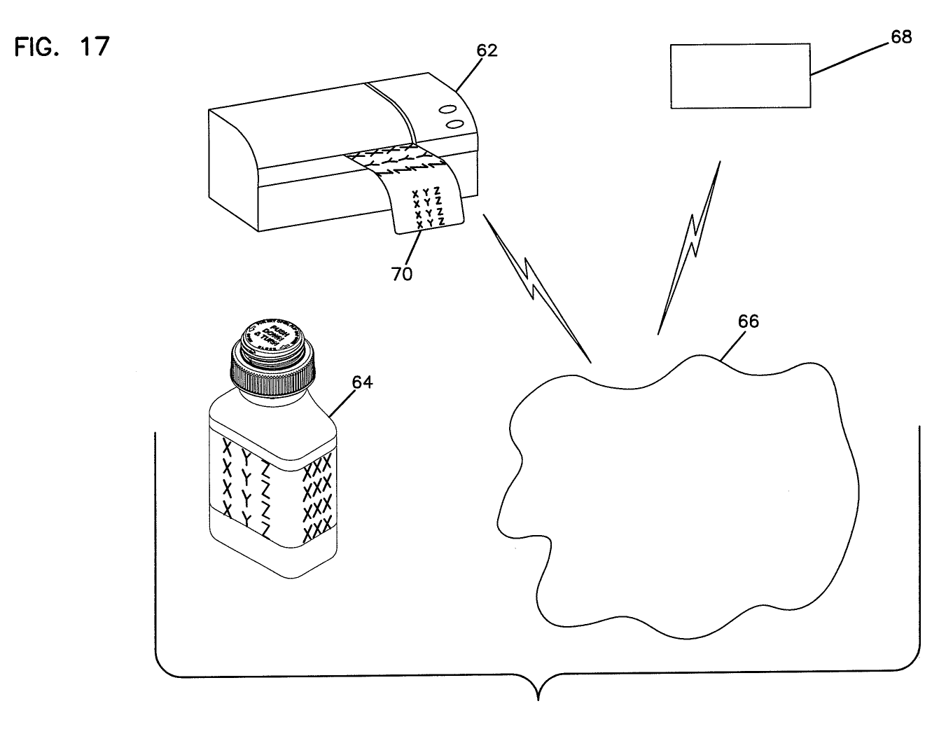

Referring to FIG. 17, a schematic illustration of the labeling network system is shown. The system includes a printer 62 at the location where the bottle is filled and labeled (e.g., a pharmacy). The printer 62 is loaded with blank labels 70 that are sized to fit a particular medication container 64, and the printer 62 is configured to print the labels 70, for example, the labels 100 shown in FIGS. 4A-4C. The printer 62 is connected to local computers and/or network computers 66 such that at least one of the doctor's office or pharmacist's office 68 can populate the fields on the label 70 with the desired information.

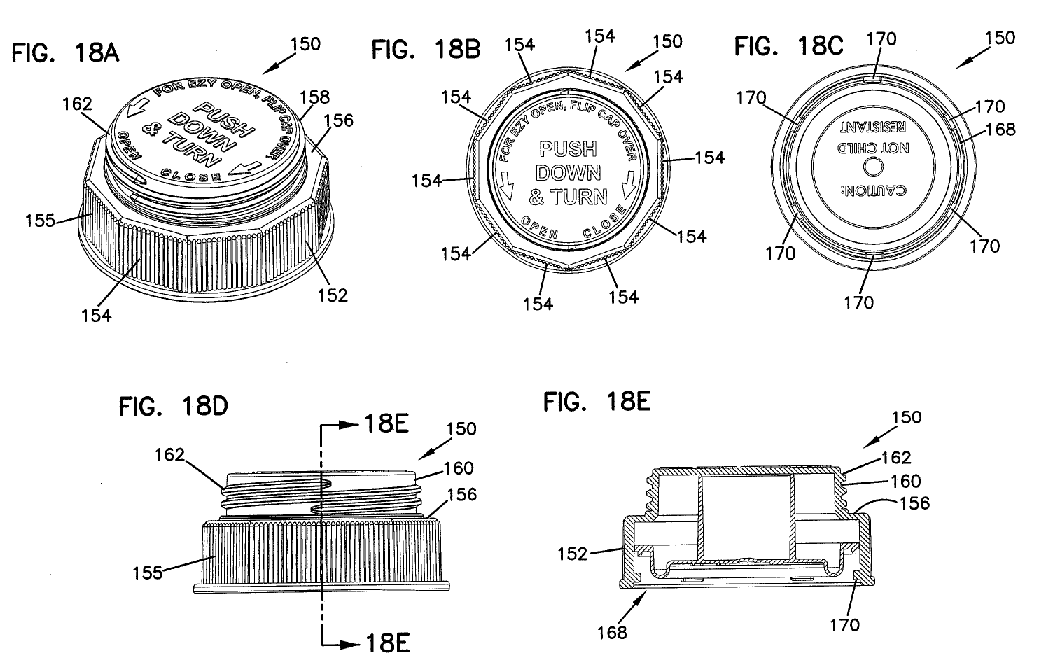

FIGS. 18A-18E show another embodiment of a two-sided cap 150 analogous to the two-sided cap 246 described in connection with FIGS. 14A-14E. In this embodiment, however, the two-sided cap 150 has an outer wall 152 that is segmented into ten sides 154. Each of the sides 154 is serrated or ribbed 155, to provide better friction or gripping action by a user. Perpendicular to the sides 154 is a platform 156. Extending from the platform 156 and radially spaced from the sides 154 is the non-child proof connection 158. The non-child proof connection 158 includes a wall 160 projecting perpendicular from the platform 156. The wall 160 includes one or more threads 162. The threads 162 engage mating threads on the bottle to provide a non-child proof screw-off connection. In FIGS. 18C and 18E, features of the child-proof connection 168 can be seen. The child-proof connection 168 includes a plurality of lugs 170. The lugs 170 engage structure on the bottle to result in a connection that is child-proof.

The above represents examples and principles of the inventive concepts. Many embodiments can be made according to these principles.

What is claimed is:

1. A medication container comprising:
an upper end configured to connect to a cap;
a lower end configured to support the container on a horizontal surface; a first surface extending from the lower end to the upper end;
a second surface extending from the lower end to the upper end;
wherein the first and second surfaces are substantially flat and oriented perpendicular to each other, wherein the area of the second surface is greater than the area of the first surface, and wherein the first surface includes text orientated vertically thereon.

2. The container of claim 1, further comprising a label on the second surface.

3. The container of claim 1, wherein the lower end is rectangular and the body of the container comprises four generally vertical walls, wherein the first and second surfaces are on the outside surface of two adjacent walls.

4. The container of claim 3, wherein the label on the first surface is a portion of a four panel label wherein each of the four panels is configured to be affixed to one of the four generally vertical walls.

5. The container of claim 4, wherein the four panels include two smaller panels and two larger panels, wherein the larger panels include the refill information and side effect information, and wherein the area of the two larger panels is greater than twice the area of the two smaller panels.

6. The container of claim 1, wherein the first surface includes three rows of text oriented vertically thereon.

7. The container of claim 6, wherein the text on the first surface includes a name of the user and a name of the medication.

8. The container of claim 7, wherein the first surface includes a first color that corresponded to a first user and a second color corresponding to a second user.

9. The container of claim 1, wherein the second surface includes text oriented horizontally thereon.

10. A method of storing medication for multiple users comprising:
providing a plurality of containers, each having a first, generally flat, surface and a second, generally flat, surface, both surfaces extending from a lower end portion to an upper end portion of each container; the first and second surfaces being oriented perpendicular to each other, and the area of the second surface being greater than the area of the first surface; and
labeling the first surface of each of the containers with the user name.

11. The method of claim 10, wherein the step of labeling includes applying a label that is color coded to correspond to a particular user.

12. The method of claim 10, wherein the step of labeling includes applying the label on the first surface to include at least one of following: the name of the medication or dosage information.

13. The method of claim 10, wherein the step of labeling includes applying the label on the first surface to not include at least one of the following: the name of the doctor that prescribed the medication, the expiration date of the medication, refill information for the medication, or side effect information.

14. The method of claim 10, wherein the step of labeling includes applying the label on the first surface to not include any one of the following: the name of the doctor who prescribed the medication, the expiration date of the medication, and refill information for the medication.

15. The method of claim 10, wherein the step of labeling includes applying the label on the second surface to include at least one of the following: directions for using the medication, the name of the doctor that prescribed the medication, or refill information for the medication.

16. The method of claim 10, wherein the step of labeling includes applying the label on the second surface to include each of the following: directions for using the medication, the name of the doctor that prescribed the medication, or refill information for the medication.

17. A method of labeling medication comprising:
printing a name of the intended user and a name of medication vertically on a first label;
printing the refill information and doctor information horizontally on a second label;
printing the side effect information horizontally on a third label;
affixing the first label on a first surface of a vial;
affixing the second label on a second surface of the vial, wherein the second surface is generally perpendicular to the first surface; and
affixing the third label to a third surface of the vial, wherein the third surface is generally parallel to the second surface.

18. The method of claim 17, wherein first, second, and third labels are sections of a single label.

19. The method of claim 17, wherein the vial has a rectangular horizontal cross-section.

20. The method of claim 17, wherein the second label is at least twice the size of the first label.
